(19) United States
(12) Patent Application Publication
(10) Pub. No.: US 2006/0154027 A1
(43) Pub. Date: Jul. 13, 2006

(54) VEHICLE DOOR TRIM BOLSTER WITH DEEP-FEEL COVER AND METHOD OF MAKING THE SAME

(76) Inventor: Alan G. Dry, Grosse Point Woods, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/905,566

(22) Filed: Jan. 11, 2005

(51) Int. Cl. B32B 3/10

(52) U.S. Cl. 428/138

(57) ABSTRACT

A door trim panel for a door frame of a motor vehicle. The door trim panel includes a substrate having a bolster and is made from a first polymer material. A cover is integrally molded with at least a portion of the bolster and is made from a second polymer material. The cover includes a plurality of spaced-apart apertures that extend into the cover to provide a soft, deep-feel cover. The bolster may be made in a two-shot molding process with the substrate being formed in the first shot of the molding process. The deep-feel cover having the plurality of spaced-apart apertures formed therein may be formed in the second shot of the molding process.

### FIELD OF THE INVENTION

The present invention pertains generally to trim assemblies for vehicle interiors, and more particularly to door bolsters having a deep-feel cover and a method of making the same.

### BACKGROUND OF THE INVENTION

It is known to provide vehicle interiors with various trim assemblies to enhance the aesthetic appearance of the interior and to provide comfort, as well as convenience, to vehicle occupants. For example, vehicle door constructions typically feature a metal door frame with a sheet metal outer panel or skin that defines the door's exterior and an inner sheet metal panel secured to the door frame. Various door components, including window regulator rails, audio speakers, latches, and the like, are fastened in openings defined in the inner sheet metal panel. Covering the inner door panel is a removable trim panel that provides an aesthetically pleasing facade viewed by occupants seated in the passenger cabin of the motor vehicle. Controls are provided on the trim panel for devices such as seats, door locks, mirror and windows. The door latch is connected by a cable to an inner release handle on the trim panel accessible to the vehicle occupant.

Door trim panels have previously been constructed as assemblies in which individual components are assembled together and attached to the panel by several different conventional processes including adhesives, heat staking, sonic welding, fasteners, etc. Such assemblies may include various trim components, such as door trim bolsters and armrests. A door trim bolster typically covers an access opening defined in the trim panel so that when the bolster is removed, a technician or assembly line worker can access the space between the trim panel and the inner door panel to install or service the door components and their drive mechanisms. Door bolsters may also be integrally formed with the trim panel when the trim panel itself is easily removable and the interior space accessible by an assembly line worker.

To improve the aesthetic appearance of trim assemblies and to improve the comfort to vehicle occupants, manufacturers strive to provide trim components with a variety of desirable properties. For instance, it is desirable to provide trim components, such as door bolsters, that have a deep, plush feel. It is also desirable that the trim components have a soft feel. Thus, trim components may be designed so that the surface readily and substantially deflects when acted upon by a relatively small force. It is further desirable that the trim components have a smooth, low friction or non-sticky feel along with a soft touch and deep cushion feel. This allows vehicle occupants to move their fingers, hands, arms, etc. across the trim component without any chafing or other discomfort.

Manufacturers currently use several methods to provide trim assemblies having trim components that have a soft touch feel. For example, trim components typically have been formed by insertion of a resilient soft padding material beneath a pliable surface or skin layer of decorative trim material, such as a textile or fabric like woven cloth, vinyl, leather, or other suitable materials having a desired tactile feel. The preformed, soft, resilient pad also may be secured to a rigid plastic shell and a pliable skin layer stretched over the pad and secured to the shell to form a trim assembly with a soft trim component, such as a door bolster. In another conventional method of forming trim assemblies with soft touch areas, a foam material may be injected between a rigid substrate and a skin layer joined to the substrate. These methods, however, have a number of drawbacks. For instance, these methods are generally costly due to the multiple components and manufacturing steps required to make the trim assemblies. Additionally, while the outer skin may be selected to provide the desired surface smoothness and the padding material may have the desired softness, a significant amount of padding material must be used to provide the deep, plush feel desired by car owners and manufacturers. This not only increases the costs of the trim assemblies, but also may make the assembly difficult to manufacture and may detract from the overall aesthetic appearance of the trim assemblies.

More recently, it is possible to use an overmolding process to form trim assemblies with soft areas that reduce the number of components and manufacturing steps. To this end, a rigid substrate is formed that provides the structural aspect of the trim assembly. A soft polymer material, such as a thermoplastic elastomer, typically is injection molded over a portion of the rigid substrate to form the soft touch areas. In many cases, however, the polymer materials that provide the soft feel also have a sticky, rubbery feel with a corresponding high friction coefficient between the vehicle occupant and the trim component. This may cause some discomfort when a vehicle occupant rubs against the trim component. Additionally, to provide the deep, plush feel, a significant amount of polymer material is often used. Thus, while the overmolding process may reduce the number of components and manufacturing steps, it remains difficult to provide trim components having the desired characteristics.

There is thus a need for an improved trim component, such as a door bolster, that provides a soft, smooth, and deep feel cover, and a method of making the same that reduces the number of parts, processing steps and the labor required for assembly thereof, thereby reducing overall manufacturing costs.

### SUMMARY OF THE INVENTION

The present invention provides a door trim panel construction adapted to be removably secured to a door frame of a motor vehicle. The trim panel includes a substrate having a bolster and is made from a first polymer material. The bolster may be formed integral with the trim panel or formed as a separate component and subsequently secured to the trim panel. The trim panel further includes a cover made from a second polymer material and is integrally molded with at least a portion of the bolster. The cover includes a plurality of spaced-apart apertures therein to provide a soft, deep feel to the bolster.

In one embodiment of the invention, the substrate is made from polypropylene and the cover is made from a thermoplastic elastomer. The cover is made from a thermoplastic elastomer having a Shore A hardness of approximately 85 and a corresponding kinetic friction coefficient of 0.65, which is in the desired range of friction values. The cover has a single-layer construction with a thickness of approximately 3.0 mm. To achieve the desired level of softness and deep feel, the cover includes a generally rectangular array of blind apertures having a diameter of approximately 2.0 mm and spaced apart by approximately 3.0 mm. The aperture depth is approximately 1.0 mm. In this way, when a typical load, e.g. 20 lbs is applied to the surface of the bolster, the surface deflects approximately 1.5 mm to provide an apparent softness and deep, plush feel that satisfy the design parameters.

In another embodiment of the invention, the cover has a multi-layered construction wherein the inner layer has a plurality of spaced-apart apertures that extend at least partially through the inner layer. The inner layer may be made of a soft thermoplastic elastomer, such as a thermoplastic elastomer having a Shore A hardness of between approximately 55-65, that does not necessarily have the desired kinetic friction coefficient. The cover further includes an outer layer that overlies the inner layer. The apertures may extend partially through the outer layer. The outer layer of the cover may be made from a thermoplastic elastomer having a Shore A hardness of approximately 85 and a corresponding kinetic friction coefficient of 0.65, which is in the desired range of friction coefficients.

The invention provides a number of advantages over conventional bolster constructions. In one advantageous aspect, the apertures formed in the cover permit increased surface deflections over covers having no apertures, thereby giving the bolster a deep, plush feel but with less material and less costs. In another advantageous aspect of the invention, the apertures give a vehicle occupant the perception of softness even though a relatively hard material is used to form the cover. Thus a harder, less expensive material may be used to achieve a desired level of softness. Furthermore, this aspect may be particularly significant when attempting to provide not only a softer bolster, but also a bolster having acceptable friction coefficients.

The deep-feel bolster having a single layer construction may be advantageously formed in a two-shot molding process. In this process, a mold assembly is provided and a first mold chamber is formed in which a first polymer material is injection molded to form a substrate including a bolster in a first shot of the molding process. The mold chamber includes a plurality of spaced-apart projections that extend through the mold chamber so as to form a plurality of spaced-apart apertures in the substrate. A second mold chamber is then formed about at least a portion of the substrate including the bolster. The projections extend through the substrate and further extend into the second mold chamber. A second polymer material is then injection molded to form a cover having a plurality of spaced-apart apertures in a second shot of the molding process. The projections may extend partially through the second mold chamber so that the apertures formed in the cover are blind apertures. The trim panel with the deep-feel bolster may be subsequently removed from the mold assembly and mounted to the door frame.

A bolster having a cover with a multi-layered construction may be formed in a three-shot molding process. In this process, a mold assembly is provided and a first mold chamber is formed in which a first polymer material is injection molded to form a substrate including a bolster in a first shot of the molding process. The mold chamber includes a plurality of spaced-apart projections that extend through the mold chamber so as to form a plurality of spaced-apart apertures in the substrate. A second mold chamber is then formed about at least a portion of the substrate including the bolster. The projections extend through the substrate and further extend into the second mold chamber. A second polymer material is then injection molded to form the inner layer of the cover in a second shot of the molding process. The projections may extend at least partially through the second mold chamber. A third mold chamber is then formed about the inner layer of the cover. A polymer material is then injection molded to form the outer layer of the cover in a third shot of the molding process. The projections may extend partially through the third mold chamber. The trim panel with the deep-feel bolster may be subsequently removed from the mold assembly and mounted to the door frame.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a front view of a door trim panel fastened to a vehicle door frame and including a bolster of the invention;

FIG. 2 is a cross-sectional view of FIG. 1 taken generally along the lines 2-2;

FIG. 2A is an enlarged view of the bolster portion of FIG. 2 but showing a multi-layer cover construction;

FIGS. 3A-3D are diagrammatic cross-sectional views illustrating a molding process for forming a bolster in accordance with the invention; and

FIG. 4 is a partial diagrammatic cross-sectional view illustrating a portion of the molding process for a bolster having a multi-layered construction.

### DETAILED DESCRIPTION OF THE DRAWINGS

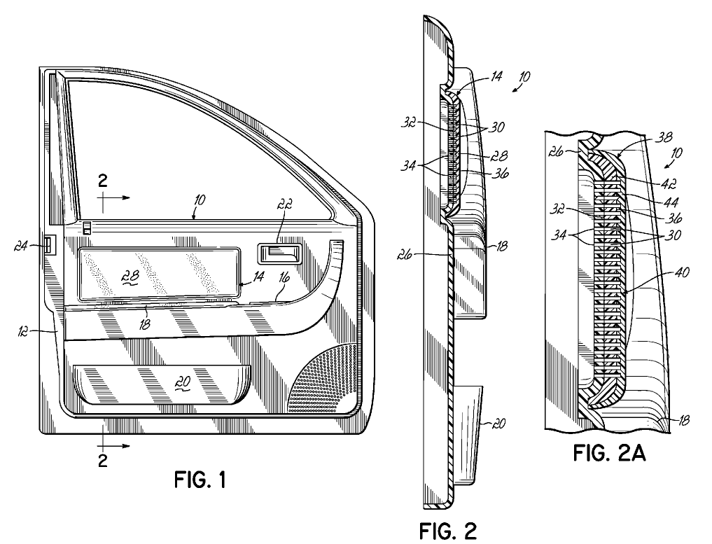

With reference to FIG. 1, a door trim panel 10 constructed in accordance with an embodiment of the invention is fastened to a door of a vehicle such as, for example, an automobile, a truck, or an aircraft. More specifically, door trim panel 10 is coupled as an assembly with, and inboard of, the inner sheet metal of a door frame 12, which has a hinged attachment with a body of a vehicle (not shown). However, persons of ordinary skill in the art will appreciate that door trim panel 10 may be used on other doors including but not limited to sliding doors, hatches, etc. Further, persons of ordinary skill in the art will also appreciate that door frame 12 may be constructed of other materials such as composites like fiberglass and carbon fibers. A passenger occupying the passenger cabin of the vehicle can manually move the assembled door relative to the vehicle body for passenger ingress and egress of the passenger cabin.

The door trim panel 10 is coupled by fasteners with door frame 12 and includes various trim components thereon including a bolster 14, a switch bezel 16, an armrest 18, and a map pocket 20. Switch bezel 16 includes electrical control panels (not shown) that carry control switches that are electrically coupled by a hidden wire harness with conventional electrically-operated components such as door locks, window controls, seat controls, and side mirrors of the automobile. An inner door release handle 22 for operating a door latch 24 is also accessible to a passenger inside the passenger cabin. An assembly line worker or service technician may access door components, such as an audio speaker, window regulator rails, a window motor, etc., mounted to the door frame 12 by removing the door panel 10 from door frame 12. While the figures and description herein show and describe bolster 14 as being integrally formed with door panel 10, one of ordinary skill in the art can appreciate that bolster 14 may also be formed as a separate trim component and then subsequently coupled to door panel 10, as is known in the art.

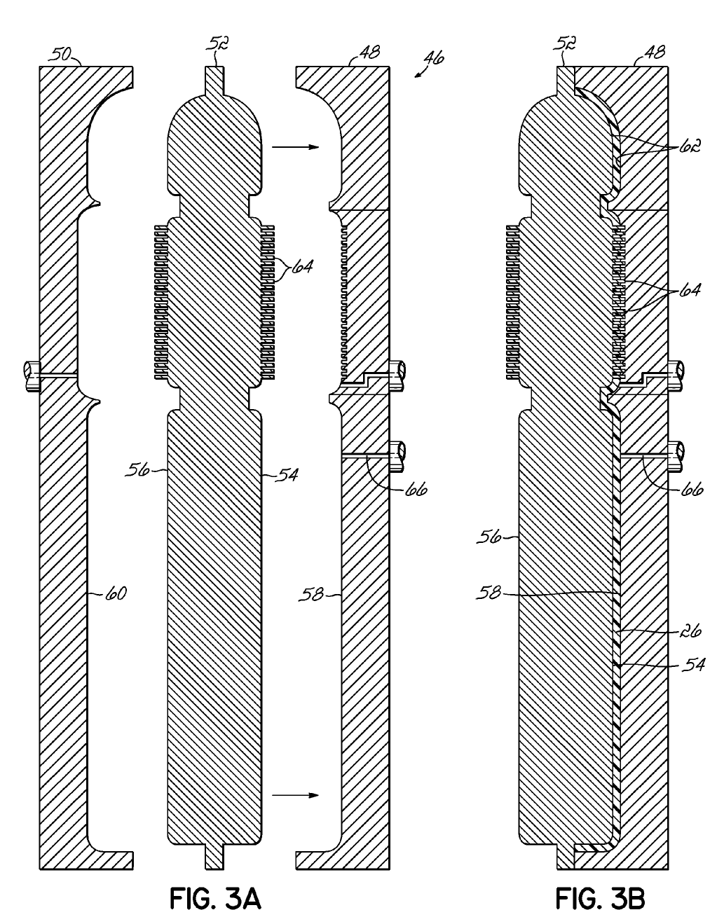

As shown in FIGS. 1 and 2, the bolster 14 includes a relatively rigid substrate 26, which forms at least a portion of the structural support and defines the general shape of the bolster 14. The substrate 26 may be made from a first polymer material, such as a structurally rigid thermoplastic or thermoset polymer material like a thermoplastic polyolefin (e.g. polypropylene). The bolster 14 further includes a deep-feel cover 28 that is integrally molded with at least a portion of substrate 26 that defines bolster 14. In an advantageous aspect of the invention, the cover 28 includes a plurality of spaced-apart apertures 30 that extend into the cover 28 from the back surface 32 that abuts substrate 26. As shown in FIG. 2, the cover 28 may have a single layer construction wherein the apertures 30 are blind apertures that partially extend through the cover 28. The cover 28 may be made from a second polymer material such as a thermoplastic elastomer or other suitable materials that can form a sufficient chemical bond with the substrate 26. Substrate 26 may additionally include a plurality of spaced-apart apertures 34 extending through substrate 26 and registering with the apertures 30 in cover 28.

The structure of bolster 14 as described above, and in particular, the apertures 30 in cover 28 provide a number of advantages that help manufacturers satisfy the various desired design parameters. In one aspect of the invention, the apertures 30 in cover 28 provide a deep, plush feel to the bolster 14. To this end, the apertures 30 permit the front surface 36 of cover 28 to deflect when acted upon by a specified force by an amount greater than the deflection of an identical cover but without apertures therein. The additional surface deflection gives a vehicle occupant the sensation, or perception, that bolster 14 has a deep, plush feel. This allows manufacturers to achieve greater surface deflections, and thus a deep feel, to bolster 14 using less material, which decreases material costs of the trim panel 10.

For instance, a conventional overmolded bolster (i.e., no apertures formed in the cover) having a cover made from a thermoplastic elastomer with a Shore A hardness of approximately 85 and a thickness of approximately 3.0 mm may have a surface deflection of approximately 0.2 mm when acted upon by a specified load, such as 20 lbs. Likewise, a conventional bolster having a cover made from a thermoplastic elastomer with a Shore A hardness of approximately 55 may have a surface deflection of approximately 0.8 mm. A bolster 14 in accordance with the invention, having the same design parameters as the conventional bolster (i.e., the same materials and cover thickness) except bolster 14 includes a plurality of spaced-apart apertures 30, will have an increased surface deflection for the same specified load. Thus, a bolster 14 having a cover 28 made from a thermoplastic elastomer with a Shore A hardness of approximately 85 and a thickness of approximately 3.0 mm may have a surface deflection of approximately 1.0 mm when acted upon by the same specified load. Likewise, a bolster 14 having a cover 28 made from a thermoplastic elastomer with a Shore A hardness of approximately 55 may have a surface deflection of over 1.5 mm. Thus, the inclusion of apertures 30 in bolster 14 increases the surface deflection for a given load as compared to the same bolster but without the apertures. This advantageously gives the vehicle occupant the perception of a deep-feel cover 28.

In another, but related, aspect of the invention, the apertures 30 in cover 28 may also provide a softer feel to the bolster 14 which provides certain advantages. A feeling of softness can depend on several factors including, for example, the “hardness” of the material that makes up cover 28 or the stiffness or rigidity of the overall bolster 14. As used herein, hardness refers to a material property as determined by a common standard or methodology, such as the Shore A hardness that is well known in the art. For example, a bolster having a cover that is made from a thermoplastic elastomer having a Shore A hardness of approximately 65 will feel soft and cushy to the touch because the front surface of the cover readily deforms when acted upon by a specified load. In other words, the cover feels soft because the material used to make the cover is itself soft and cushy.

In an advantageous aspect of the invention, however, a bolster 14 having a cover 28 made from a thermoplastic elastomer having a Shore A hardness of approximately 85, which is relatively rigid to the touch, has an “apparent softness” because the apertures 30 permit the front surface 36 of cover 28 to deflect when acted upon by a specified load. In other words, bolster 14 does not feel soft because the cover material is itself soft, but bolster 14 appears to be soft because the structure, via apertures 30, permits surface deflections when acted upon by a specified load. This allows manufacturers to meet softness requirements even when using relatively rigid materials. This may reduce costs as polymer materials having a lower hardness, i.e., softer materials, tend to more expensive.

The ability to provide an apparent softness, via the apertures 30, using a cover 28 made from a material having a relatively high hardness, such as a Shore A hardness between approximately 75-85, also becomes significant to providing a bolster 14 having a smooth, low friction front surface 36. As is known in the art, there is a general relationship between the hardness of a material and its kinetic coefficient of friction. In particular, hardness and friction material properties tend to be inversely related, i.e., the higher the hardness, the lower the kinetic coefficient of friction and vice versa. As a result, with many materials, including many thermoplastic elastomers, it may be difficult to provide a bolster having both the desired level of softness while also providing a smooth, low friction feel to the front surface of the cover. Thus, in another advantageous aspect of the invention, because the apertures 30 in cover 28 provide an apparent softness, even when using a relatively hard material, a bolster 14 having the desired level of softness (albeit an apparent softness) and further having the desired level of friction may be realized.

By way of example, thermoplastic elastomers having a Shore A hardness between approximately 75-85 generally have kinetic friction coefficients between approximately 1.03 and 0.65, respectively, which are generally within the desired range. However, conventional bolsters having covers with a Shore A hardness in this range are generally thought to provide inadequate softness. Conversely, conventional bolsters having covers with a Shore A hardness below this range (e.g. 55-65), and thereby being softer, are generally thought to provide undesirable kinetic friction coefficients. The bolster 14 in accordance with the invention, however, because of the presence of apertures 30 in cover 28, provides an apparent softness that is within the desired range while also providing kinetic friction coefficients within the desired range. Thus, by manipulating a structural aspect of the cover 28, i.e., using apertures 30 in cover 28, manufacturers can provide bolsters 14 that not only have a deep, plush feel, but also satisfy their desired softness and desired friction requirements.

To this end, and in one embodiment of the invention as shown in FIG. 2, the substrate 26 may be made from polypropylene and the cover 28 may be made from a thermoplastic elastomer. To satisfy the desired friction requirements, the cover 28 is made from a thermoplastic elastomer having a Shore A hardness of approximately 85. At this hardness, the thermoplastic elastomer typically has a kinetic friction coefficient of approximately 0.65, which is in the desired range. The thickness of the cover 28 is approximately 3.0 mm. To achieve the desired level of softness and the desired level of deep feel, the back surface 32 of cover 28 includes a generally rectangular array of apertures 30 configured as blind apertures. The apertures 30 have a generally circular cross section with a diameter of approximately 2.0 mm. Moreover, the apertures 30 are spaced approximately 3.0 mm apart (center-to-center). The aperture depth is also approximately 1.0 mm. With this configuration, when a load, such as approximately 20 lbs, is applied to the front surface 36 of cover 28, the surface deflects approximately 1.5 mm to provide an apparent softness and a deep, plush feel that satisfy the design parameters.

As one of ordinary skill in the art can appreciate, the feel of the cover 28 may be varied, or adjusted, to a desired result by changing various aspects of the apertures 30. For example, instead of a rectangular configuration, other configurations or patterns are possible and may be selected based on a particular application. Additionally, the apertures 30 may have other cross sections, including square, hexagonal, star-shaped, etc. Moreover, the cross-sectional area of the apertures 30 and the spacing between adjacent apertures 30 may be varied to provide a desired result. It is further contemplated that the aperture depth, i.e., the distance the apertures 30 penetrate cover 28 may be varied to provide a desired result. For instance, the apertures 30 may penetrate between approximately 20 and 80 percent of the cover thickness, depending on the particular application. Also, those of ordinary skill in the art will recognize that the thickness of the cover 28 may be varied to provide a desired result.

An alternate embodiment of the bolster of the invention is shown in FIG. 2A, in which like reference numerals refer to like features in FIG. 2. In particular, the bolster 38 includes a multi-layered cover 40 with at least one inner layer 42 (only one shown) and an outer layer 44. One or more inner layers 42 may be provided to further enhance the softness and deep plush feel of bolster 38. The inner layer 42 includes a plurality of spaced-apart apertures 30 that extend at least partially through the inner layer 42 and may extend completely through inner layer 42, as shown in FIG. 2A. Those of ordinary skill in the art will recognize that when there are multiple inner layers, the apertures 30 may extend partially through the multiple inner layers or completely through the multiple inner layers. In any event, the outer layer 44 overlies the inner layer 42 so that the apertures 30 are not visible by occupants inside the vehicle. The outer layer 44 may be a decorative layer, such as a vinyl, leather or cloth layer, but preferably is another injection molded layer. For an injection molded outer layer 44, it should be recognized that the apertures 30 may partially extend through the outer layer 44 to form blind aperture therein.

The substrate 26 may be made from polypropylene as in the previous embodiment. The inner layer 42 may be made from a soft thermoplastic elastomer and have a thickness of between approximately 1-3 mm. However, because the inner layer 42 is not exposed to vehicle occupants, inner layer 42 does not necessarily need to meet any friction requirements. Consequently, a thermoplastic elastomer having a relatively low Shore A hardness, such as between approximately 55-65, may be used for the inner layer 42. This enhances the softness of the bolster 38. To satisfy the desired friction requirements, however, the outer layer 44 is made from a thermoplastic elastomer having a Shore A hardness of approximately 85. As with the cover 28 in the previous embodiment, at this hardness the thermoplastic elastomer typically has a kinetic friction coefficient of approximately 0.65, which is in the desired range. The thickness of the outer cover 44 is approximately 3.0 mm. Apertures 30 are formed in the bolster 38 generally in the same configuration as described for FIG. 2. The apertures 30 extend at least partially through inner layer 42 and may extend completely through inner layer 42. In the latter case, the apertures 30 may further partially extend into the outer layer 44 when for example, that layer is an injection molded layer. For instance, as shown in FIG. 2A, the apertures 30 extend completely through inner layer 42 and further extend into outer layer 44 for approximately 1.0 mm. As mentioned previously, those of ordinary skill in the art will appreciate that bolster 38 may include more than one inner layer 42.

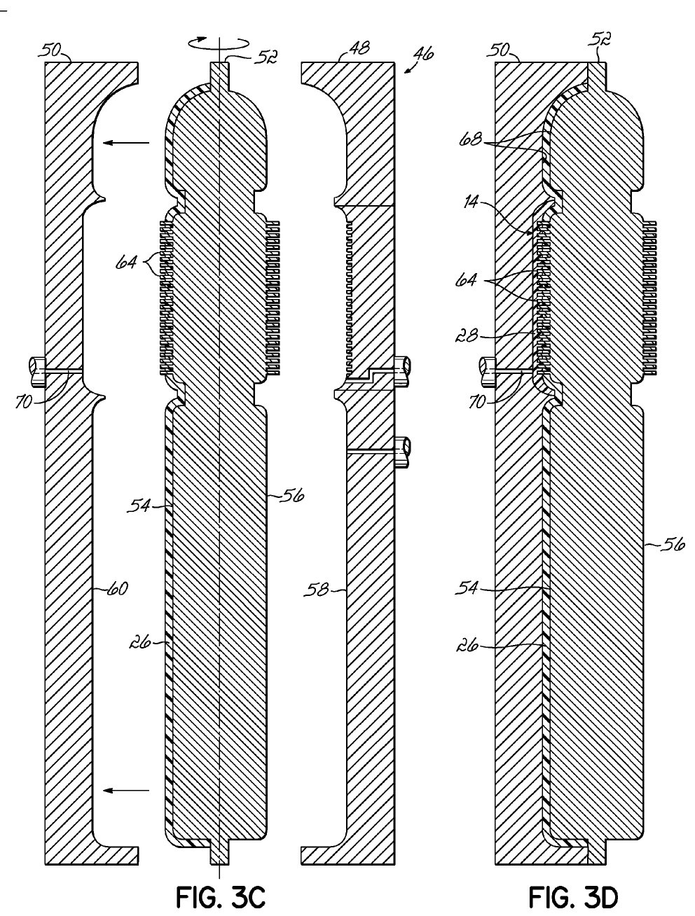

With reference to FIGS. 3A-3D, a method of making the bolster 14 with a deep-feel cover 28 will now be described. In an advantageous aspect of the invention, the bolster 14 may be formed in a two-shot molding process. A single mold assembly 46 includes spaced-apart first and second members 48 and 50, and a mold core 52 situated between the members 48, 50. The mold core 52 has opposite first and second cavities 54, 56 each adapted to confront and mate with one of a corresponding first and second cavities 58, 60 defined in the members 48, 50. The mold core 52 is adapted to pivot so that the first and second cavities 54, 56 are confronting, in turn, with the first and second cavities 58, 60 to injection mold, in sequence, first the substrate 26, then the cover 28. While the first and second shots of the injection molding operation are described below with respect to the first cavity 54, it is understood that the first and second shots of the two-shot molding operation may occur in the same fashion with respect to the second cavity 56.

As shown in FIGS. 3A-3B, the first cavity 54 of the mold core 52 is moved into alignment with mold cavity 58 and mated with the first member 48 to define a closed first shot mold chamber 62 defined by cavities 54 and 58. The first shot mold chamber 62 generally defines the shape of substrate 26 and includes the bolster 14. Mold cavity 54 in mold core 52 includes a plurality of spaced-apart projections 64, such as pins, that extend into and through mold chamber 62. The projections 64 may be formed by placing an appropriately shaped mold insert into mold chamber 62. Alternately, the projections 64 may be an integral part of cavities 54 and 56 in core 52. In this case, projections 64 may be moveable with respect to core 52 to adjust the length of the projections 64. In a first shot of the molding operation, a first molten polymer suitable for forming substrate 26 is injected through a channel 66 and into mold chamber 62. The first polymer material may be a structurally rigid thermoplastic or thermoset polymer material like a thermoplastic polyolefin such as polypropylene. Projections 64 form a plurality of spaced-apart apertures 34 through substrate 26.

As shown in FIGS. 3B-3D, the first member 48 is moved away from the mold core 52 and core 52 is rotated so that the first cavity 54 carrying substrate 26 confronts and mates with the second cavity 60 to define a closed second shot mold chamber 68 about at least a portion of the substrate 26. The second shot mold chamber 68 generally defines the shape of cover 28. The projections 64 extend through substrate 26 and further extend into the second shot mold chamber 68. In a second shot of the two-shot molding operation, a second molten polymer material is injected through a channel 70 and into second mold chamber 68 to form the cover 28. The second polymer material may be a thermoplastic elastomer or other suitable materials. The projections 64 extend partially through the mold chamber 68 so that the apertures 30 in cover 28 are blind apertures.

After the bolster 14 has cooled, the second member 50 is moved away from the core 52, and the bolster 14 is ejected, such as by ejector pins (not shown), from the first cavity 54. The molding process is repeated to form additional bolsters 14. Although not illustrated, it is understood that the second cavity 56 also is adapted to confront and mate with the first member 48, during the mating of the first cavity 54 with the second member 50, to form a second substrate (not shown) identical to the first substrate 26 by injecting molten polymer into the first shot mold chamber defined by cavities 56, 58 in the first shot of the molding operation. After injection, the mold core 52 is rotated to align the second cavity 56 with cavity 60 in the second member 50 and mated to define a second shot chamber for the second shot of the molding operation while the first cavity 54 returns to a confronting relationship with cavity 58 in the first member 48 to repeat the first shot of the molding operation. In this fashion, multiple bolsters 14 may be serially formed in a continuous and efficient manner.

Although the method of making utilizes a single mold assembly 46 for a continuous, integrated process, it still should be understood that the molding process may be performed in more than one mold assembly such that the bolster 14 may be moved from the first shot mold cavity after the first shot to a second shot mold cavity provided in a second, separate mold assembly (not shown) for the second shot of the molding operation. Bolster 14 may also be formed by other multi-component molding processes known to those skilled in the art. For example, substrate 26 and cover 28 may be formed by a co-injection molding process in which two or more molten polymers are sequentially or simultaneously injected into the same mold.

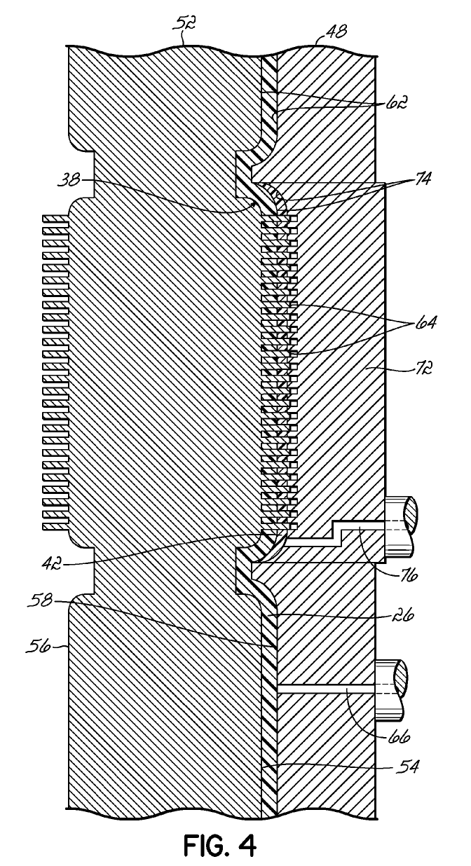

A method of making bolster 38 having a multi-layered cover 40 where the outer layer 44 is injection molded is similar in many respects to that described above. For this reason, the mold assembly shown in FIGS. 3A-3D will be used to describe the method as it applies to bolster 38. In reference to FIGS. 3A-3D and in further reference to FIG. 4, the bolster 38 may be formed in a three-shot molding process. The formation of the substrate 26 is substantially similar to that described above. Thus, the first cavity 54 is moved into alignment with mold cavity 58 and mated with the first member 48 to define a closed first shot mold chamber 62 defined by cavities 54 and 58. A first molten polymer suitable for forming substrate 26 is injected through the channel 66 and into mold chamber 62. The first polymer material may be a structurally rigid thermoplastic or thermoset polymer material like a thermoplastic polyolefin such as polypropylene. Projections 64 form a plurality of spaced-apart apertures 34 through substrate 26.

As best shown in FIG. 4, to form the inner layer 42, the first member 48 includes a moveable slide 72 along first member 48 that forms bolster 38. The moveable slide is capable of movement away from and toward mold core 52. After substrate 26 is formed in the first shot of the molding operation, the moveable slide 72 is moved away from mold core 52 so as to define a closed second shot mold chamber 74 between the substrate 26 and moveable slide 72. The projections 64 may extend partially or completely through mold chamber 74. In a second shot of the molding operation, a second molten polymer material is injected through a channel 76 and into the mold chamber 74 so as to form the inner layer 42. The second polymer material may be a soft material, such as a thermoplastic elastomer having a Shore A hardness of between approximately 55-65 or other suitable materials. The first member 48 is then moved away from the mold core 52 and the mold core 52 rotated so that the first cavity 54 carrying substrate 26 and inner layer 42 confronts and mates with the mold cavity 60 so as to form the outer layer 44. The outer layer 44 is then formed in a third shot of the molding operation in substantially the same manner as described above for cover 28. The polymer material for the third shot may be a thermoplastic elastomer, such as a thermoplastic elastomer having a Shore A hardness of between approximately 75-85 or other suitable materials.

It should be recognized by those of ordinary skill in the art that while the invention has been shown and described as a door bolster, the invention is not so limited as the invention may be used with other interior trim assemblies. In particular, the invention is advantageous for vertically oriented surfaces in the automotive interior. For example, interior trim assemblies such as glove box covers, instrument panels, knee bolsters, and others may benefit from the present invention.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A door trim panel for attachment to a door frame of a vehicle, comprising:
a substrate including a bolster made from a first polymer material; and
a cover made from a second polymer material and integrally molded with at least a portion of said bolster, said cover having a plurality of spaced-apart apertures therein and configured to provide a soft, deep feel to said bolster.

2. The trim panel of claim 1, wherein said apertures are blind apertures.

3. The trim panel of claim 1, wherein said cover is formed by one layer.

4. The trim panel of claim 1, wherein said cover is formed by two or more layers.

5. The trim panel of claim 1, wherein said substrate further comprises:
a plurality of spaced-apart apertures extending through said substrate and registering with said spaced-apart apertures in said cover.

6. The trim panel of claim 1, wherein said first polymer material is selected from the group consisting of a thermoplastic polymer and a thermoset polymer.

7. The trim panel of claim 1, wherein said second polymer material is a thermoplastic elastomer.

8. The trim panel of claim 1, wherein said first polymer material is a polyolefin and said second polymer material is a thermoplastic elastomer.

9. The trim panel of claim 1, wherein said second polymer material has a Shore A hardness between approximately 75 and 85.

10. The trim panel of claim 1, wherein said second polymer material has a kinetic friction coefficient between approximately 0.65 and 1.03.

11. The trim panel of claim 1, wherein said cover comprises:
an inner layer made from a thermoplastic elastomer having a Shore A hardness between approximately 55-65; and
an outer layer made from a thermoplastic elastomer having a kinetic friction coefficient between approximately 0.65 and 1.03.

12. A method of making a door trim panel having a deep-feel bolster, comprising:
forming a first mold chamber;
molding a substrate including a bolster by injecting a first polymer material into the first mold chamber in a first shot of a molding operation;
forming a second mold chamber about at least a portion of the bolster; and
molding a cover having a plurality of spaced-apart apertures therein with the bolster by injecting into the second mold chamber a second polymer material in a second shot of the molding operation.

13. The method of claim 12, wherein molding a cover having a plurality of spaced-apart apertures comprises:
forming the first mold chamber having a plurality of spaced-apart projections extending through the first mold chamber so as to form a plurality of spaced-apart apertures in the substrate during the first shot of the molding operation; and
forming the second mold chamber so that the projections extend through the substrate and further extend into the second mold chamber so as to form the plurality of spaced-apart apertures in the cover during the second shot of the molding operation.

14. The method of claim 13, wherein the projections extend partially through the second mold chamber so that the apertures in the cover are blind apertures.

15. The method of claim 12, wherein the first polymer material is selected from the group consisting of a thermoplastic polymer and a thermoset polymer.

16. The method of claim 12, wherein the second polymer material is a thermoplastic elastomer.

17. The method of claim 12, wherein the first polymer material is a polyolefin and the second polymer material is a thermoplastic elastomer.

18. The method of claim 12, wherein injecting the second polymer material comprises:
injecting a second polymer material having a Shore A hardness between approximately 75 and 85.

19. The method of claim 12, wherein injecting the second polymer material comprises:
injecting a second polymer material having a kinetic friction coefficient between approximately 0.65 and 1.03.

20. The method of claim 12, wherein the cover includes an inner layer and an outer layer, the inner layer being formed in the second shot of the molding process, the method further comprising:
forming a third mold chamber about at least a portion of the bolster; and
molding the outer layer with the bolster by injecting into the third mold chamber a polymer material in a third shot of the molding operation.
